(19) United States
(12) Patent Application Publication
(10) Pub. No.: US 2008/0108247 A1
(43) Pub. Date: May 8, 2008

(54) HEADREST ENTERTAINMENT SYSTEM

(76) Inventor: Jeff Macholz, Patchogue, NY (US)

Correspondence Address: F. CHAU & ASSOCIATES, LLC, 130 WOODBURY ROAD, WOODBURY, NY, 11797, US

(21) Appl. No.: 11/697,563

(22) Filed: Apr. 6, 2007

Related U.S. Application Data
(63) Continuation-in-part of application No. 11/593,306, filed on Nov. 6, 2006.

(51) Int. Cl. B60R 11/02; H01R 3/00

(52) U.S. Cl. 439/501; 224/275

(57) ABSTRACT

A method for preparing a wire for installation in a headrest entertainment system includes forming a receiving portion in a headrest, inserting a first wire having first connectors through a headrest post and into the receiving portion, mounting a media device to the headrest, the media device comprising a second wire having second connectors, connecting the first connectors and the second connectors, folding the connected first wire and the second wire, placing the folded wires inside a connector cover, and inserting the connector cover into the receiving portion.

### CROSS REFERENCE TO RELATED APPLICATION

This application is a Continuation-in-Part of U.S. application Ser. No. 11/593,306, filed on Nov. 6, 2006, the disclosure of which is incorporated herein in its entirety by reference,

### BACKGROUND OF THE INVENTION

1. Technical Field

The present disclosure relates to methods and devices for preparing wires, and more particularly to methods and devices for preparing wires for installation in a headrest entertainment system for a vehicle.

2. Discussion of Related Art

An entertainment system for a vehicle, such as a headrest entertainment system, is popular because passengers can enjoy audio and video entertainment on the road. The headrest entertainment system includes, for example a media unit with a display, and a media player. The media player can be formed in the media unit or other parts of the vehicle.

The media unit can be electrically connected to a media player in another headrest, for example, a DVD player, via connectors attached to, for example, a wire harness and/or a distribution box. The connectors are formed at the end of a wire(s), which run from the media unit. The connectors are also formed at the end of a wire(s), which run from the wire harness and/or the distribution box. The wire(s) including connectors can be fed up headrest supports into the headrest. The connectors from the media unit and the connectors from the wire harness are connected and placed in the headrest. However, the connector/wire harness combination occupies large space in the headrest.

Thus, a need exists for a wire organizing method for reducing the amount of space occupied by the connector/wire harness combination in the headrest.

### SUMMARY OF THE INVENTION

According to an embodiment of the present invention, a method for preparing a wire for installation in a headrest entertainment system includes forming a receiving portion in a headrest, inserting a first wire having first connectors through a headrest post and into the receiving portion, mounting a media device to the headrest, the media device comprising a second wire having second connectors connecting the first connectors and the second connectors, folding the connected first wire and the second wire, placing the folded wires inside a connector cover, and inserting the connector cover into the receiving portion.

The method may further comprise wrapping the first connectors attached to the first wire with a wire wrapper for covering the first connectors, feeding the first wire through the headrest post, and removing the wire wrapper.

Placing the folded wires inside the connector cover may comprise opening the connector cover, and closing the connector cover around the folded wires.

The receiving portion may receive the headrest post.

The receiving portion can be formed near a bottom of the headrest.

Two receiving portions can be formed near bottom corners of the headrest.

The connector cover can be formed in a tube shape.

The tube-shaped connector cover may comprise a cavity.

The connectors may comprise electrical components for providing at least one of power, ground and audio/video connections for the entertainment system.

According to an embodiment of the present invention, a headrest entertainment system for a vehicle comprises a headrest including a receiving portion, a first wire having first connectors, a media device disposed in the headrest, and including a second wire having second connectors, and a connector cover for receiving mated first and second wires, wherein the connector cover is disposed in the receiving portion.

The connector cover may comprise a cavity formed therein.

The connector cover may be formed in a tube shape.

Two receiving portions can be formed near bottom corners of the headrest.

According to an embodiment of the present invention, a device for preparing a wire for installation in a headrest entertainment system for a vehicle comprises a connector cover for receiving the wire including a plurality of connectors in a cavity formed in the connector cover.

The connector cover may be formed in a tube shape.

The connector cover may comprise at least an opening through which the wire is inserted into the cavity.

The tube-shaped connector cover can be opened into two pieces to receive the wire in the cavity.

The connector cover may comprise plastic.

### BRIEF DESCRIPTION OF DRAWINGS

Exemplary embodiments of the present invention can be understood in more detail from the following descriptions taken in conjunction with the accompanying drawings, of which:

FIG. 1 shows a headrest entertainment system with shrink-wrapped wire connectors, according to an embodiment of the present invention;

FIG. 2 shows a close-up view of the shrink-wrapped connectors of FIG. 1;

FIG. 3 shows a top view of a headrest entertainment system with a media unit pivoted outward with respect to a headrest, according to an embodiment of the present invention;

FIG. 4 shows a view of wire connectors wrapped in braided sleeving, according to an embodiment of the present invention;

FIG. 5A shows a front view of a headrest including a wired connection, according to an embodiment of the present invention;

FIG. 5B shows a close-up view of the wired connection shown in FIG. 5A, according to an embodiment of the present invention;

FIGS. 6A-6B show an electrical connector running from a media unit, according to an embodiment of the present invention;

FIG. 6C shows a connector positioned in the media unit for receiving the electrical connector shown in FIG. 6D, according to an embodiment of the present invention;

FIG. 6D shows an electrical connector, according to an embodiment of the present invention;

FIG. 7 shows a front view of a headrest including a first receiving portion and a second receiving portion according to an embodiment of the present invention;

FIG. 8 shows a wire inserted into a first receiving portion according to an embodiment of the present invention;

FIG. 9 shows a front view of a headrest and a media unit attached to the headrest according to an embodiment of the present invention;

FIG. 10 shows wires and connectors routed out of a headrest according to an embodiment of the present invention;

FIG. 11 shows connectors mated each other according to an embodiment of the present invention;

FIG. 12a shows connectors and wires folded and inserted into a connector cover according to an embodiment of the present invention;

FIG. 12b shows a front view of a connector cover according to an embodiment of the present invention;

FIG. 13 shows wires and connectors placed in a connector cover according to an embodiment of the present invention;

FIG. 14 shows a connector cover placed in a receiving portion of a headrest according to an embodiment of the present invention;

FIG. 15 shows a bottom view of a headrest according to an embodiment of the present invention;

FIG. 16 shows a cross-sectional view of a headrest taken along the line I-I′ of FIG. 15 according to an embodiment of the present invention; and

FIG. 17 shows a headrest harness according to an exemplary embodiment of the present invention.

### DETAILED DESCRIPTION OF EXEMPLARY EMBODIMENTS

Exemplary embodiments of the present invention will now be described more fully hereinafter below in more detail with reference to the accompanying drawings. This invention may, however, be embodied in different forms and should not be construed as limited to the embodiments set forth herein.

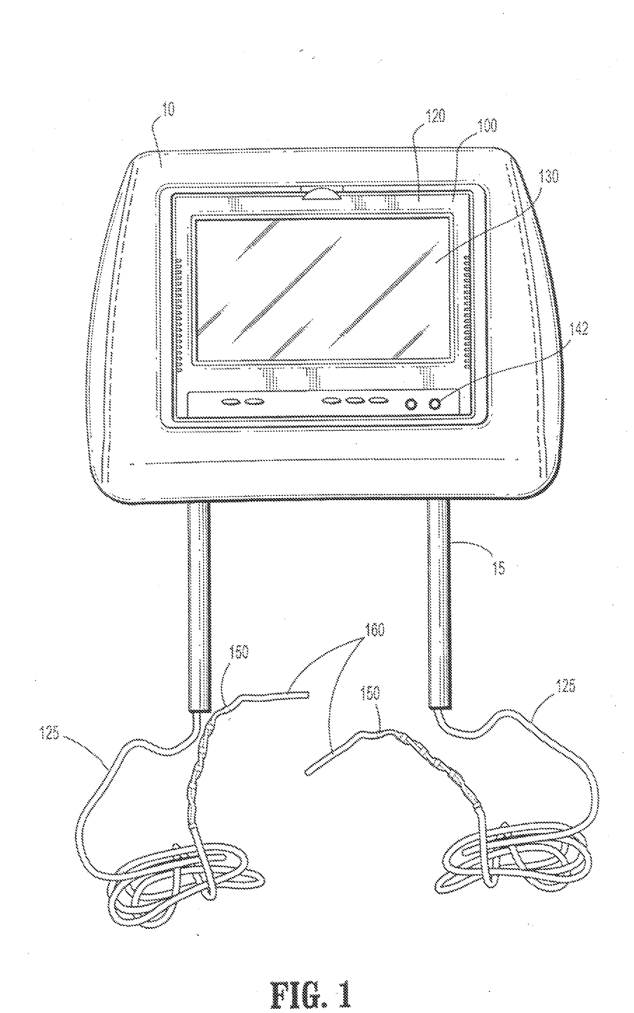

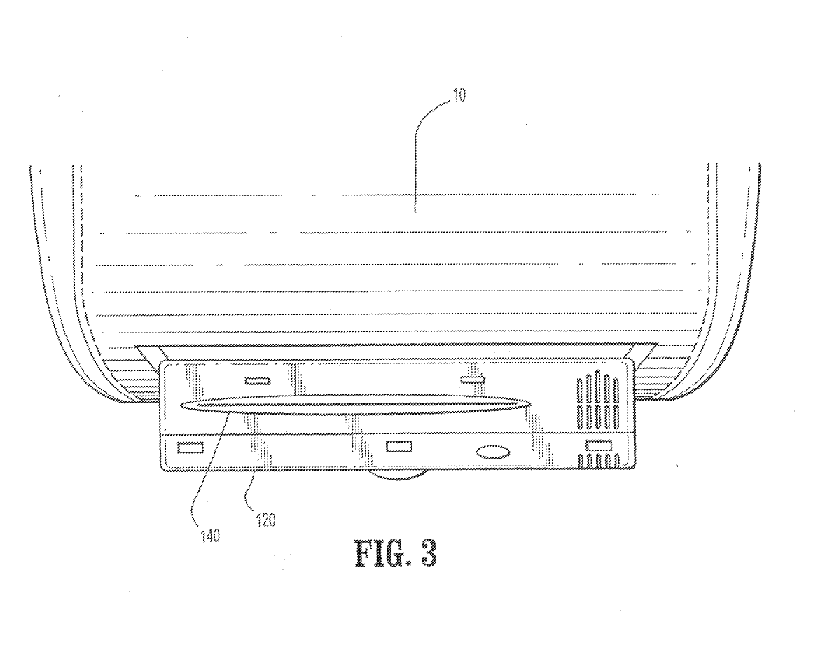

Referring to FIG. 1, a headrest 10 includes an entertainment system 100 mounted therein. The entertainment system 100 includes a media unit 120 with a display 130 having a screen for displaying a video program. The screen is preferably an LCD type display, but may be another type of display, such as, for example, an organic LED or electro-luminescent display. The video program is supplied from a media player, for example, a DVD player 140 provided behind the display 130 (see FIG. 3). The media source may also be, for example, a CD-ROM player, a video game player, a videocassette player, a television tuner, a radio tuner, a wireless receiver, an MP3 player, a digital video recorder, and/or a device for playing media supplied from a portable storage device (ergo, a portable hard drive, memory cards, flash memory sticks, key drives, thumb drives). Alternatively, the display 130 can be electrically connected to an auxiliary media source through auxiliary port 142.

In another alternative, the display is electrically connected to a media player, for example, another DVD player in another headrest, via one of the connectors 150 attached to, for example, a wire harness, a power supply, and/or a distribution box (not shown). The connectors 150 are formed at the end of a wire(s) 125, which run from the entertainment system 100. For example, the wire 125 may include a plurality of wires, and each connector 150 can be attached to each of the plurality of wires. The wire(s) 125, including connectors 150 are fed through the headrest supports 15 and the connectors 150 are connected to, for example, the wire harness. The connectors 150 preferably include electrical connectors, for example, pin connectors, for connecting to the wire harness. The connectors 150 provide, for example, power, ground, and audio/video inputs and outputs to and from the entertainment system 100. For example, video from DVD player 140 may be supplied to a display located in another headrest of the vehicle. The connectors 150 also include control lines for a wireless modulator for supplying wireless audio to a vehicle sound system or for communication of the video, audio or control signals between the media player and display 130.

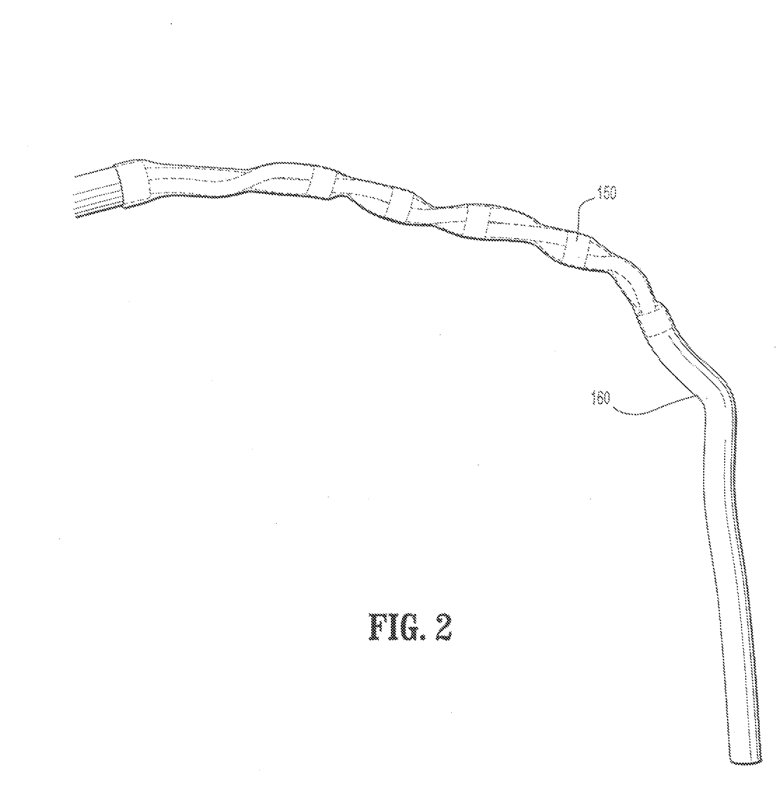

Referring to FIGS. 1 and 2, in order to facilitate feeding of the wires 125 including the connectors 150 from an upper portion of the headrest 10 through the headrest posts 15, the connectors 150 are shrink wrapped in, for example, heat shrink tubing 160. The heat shrink tubing 160 is such that it provides a compact and low profile covering for the connectors 150 by conforming to the size and shape of the connectors 150. The heat shrink tubing 160 preferably includes partially polymerized plastic. The heat shrink tubing 160 may be formed from material, such as, for example, polyolefin and fluoropolymer resins, such as, fluorinated ethylene propylene (FEP) and perfluoroalkoxy (PFA).

Once passed through the headrest posts 15, and fed to the wire harness, a user/installer of the headrest entertainment system can remove the tubing 160 by, for example, cutting off the tubing 160, thereby exposing the connectors 150 so that the connectors 150 can be mated with, for example, the harness.

In an embodiment of the present invention, the wires 125 including the connectors 150 can be fed up the headrest posts 15 into the headrest 10. In order to facilitate feeding of the wires 125 including the connectors 150 from the headrest posts 15 through the headrest 10, the connectors 150 are shrink wrapped in, for example, heat shrink tubing 160 or braided sleeving 170. Once passed through the headrest posts 15, and fed to the wire harness, a user/installer of the headrest entertainment system can remove the tubing 160 by, for example, cutting off the tubing 160, thereby exposing the connectors 150 so that the connectors 150 can be mated with, for example, the harness.

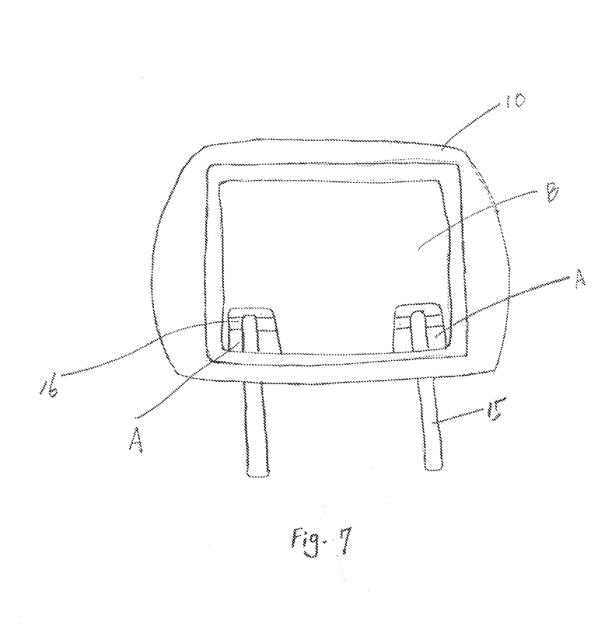

In an embodiment, the connectors 150 mated with the harness can be folded or bent, for example, in half for reducing the amount of space occupied by the connector/harness combination and placed inside a connector cover (not shown). The connector cover, enclosing the connectors 150 mated with the harness, can be placed inside the headrest 10. Detail descriptions are illustrated in connection with FIGS. 7-16.

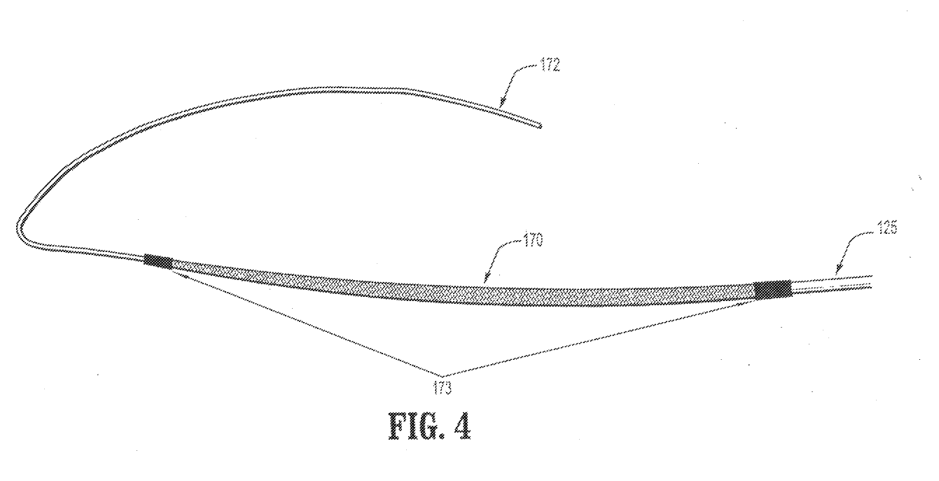

Referring to FIG. 4, as an alternative to the heat shrink tubing 160, braided sleeving 170 can be used to wrap the connectors 150. The braided sleeving 170 may be formed from, for example, polyethylene terepthalate (PET), fiberglass, and/or polyester. In an embodiment, a stiff wire 172 is attached to wire 125 at a location near the end of the braided sleeving 170. The stiff wire further facilitates feeding of the wire 125 through the headrest posts 15 and through a seat to which the headrest 10 is mounted. The stiff wire 172 provides a rigid member which can be gripped, by, for example, a wire puller, to enable smooth feeding of the wire 125 through the headrest post 15 to the bottom of a seat. The stiff wire 172 may comprise metal, such as, for example, aluminum, spring steel or plastic. In another alternative, the stiff wire 172 may also be attached at the end of the heat shrink tubing 160.

As shown in FIG. 4, tape 173, for example, electrical tape, is wrapped around the wire 125 at the ends of the braided sleeving 170 to protect the connectors 150 and to hold the stiff wire 172 in place. As an alternative to the tape 173, heat shrink tubing may be used.

At the bottom of a seat, when the connectors 150 are to be mounted to a wire harness, the tape 173 (or heat shrink tubing) is removed by a user/installer by, for example, cutting the tape 173 (or heat shrink tubing). Then, the braided sleeving 170 is removed by carefully pulling on the wire 125 and holding the braided sleeving 170. The braided sleeving 170 may be expanded by pushing around the end of the braided sleeving 170 where the tape 173 (or heat shrink tubing) was removed.

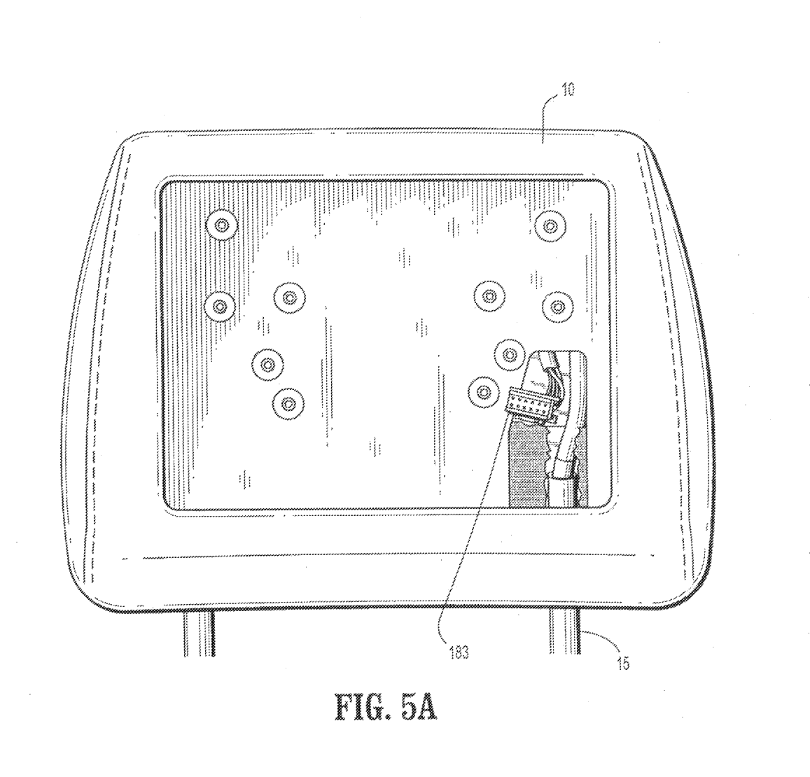

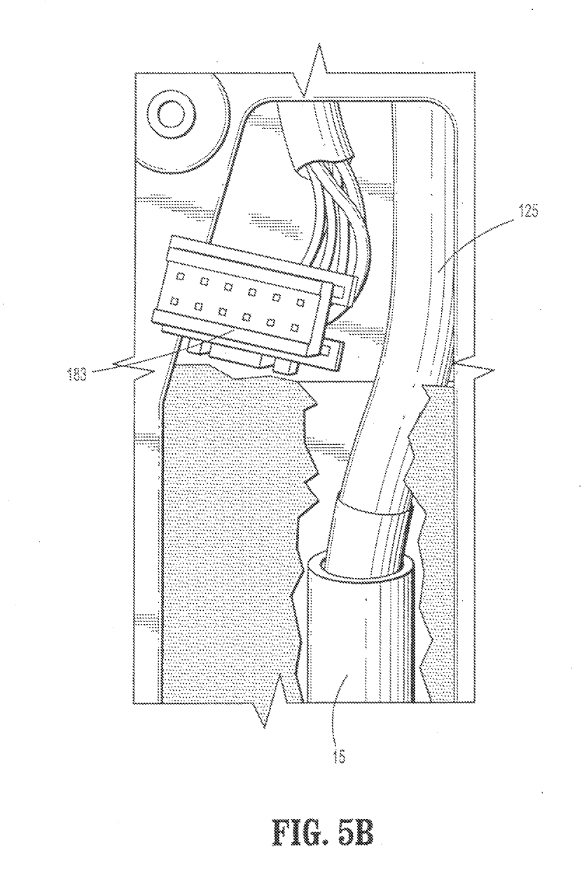

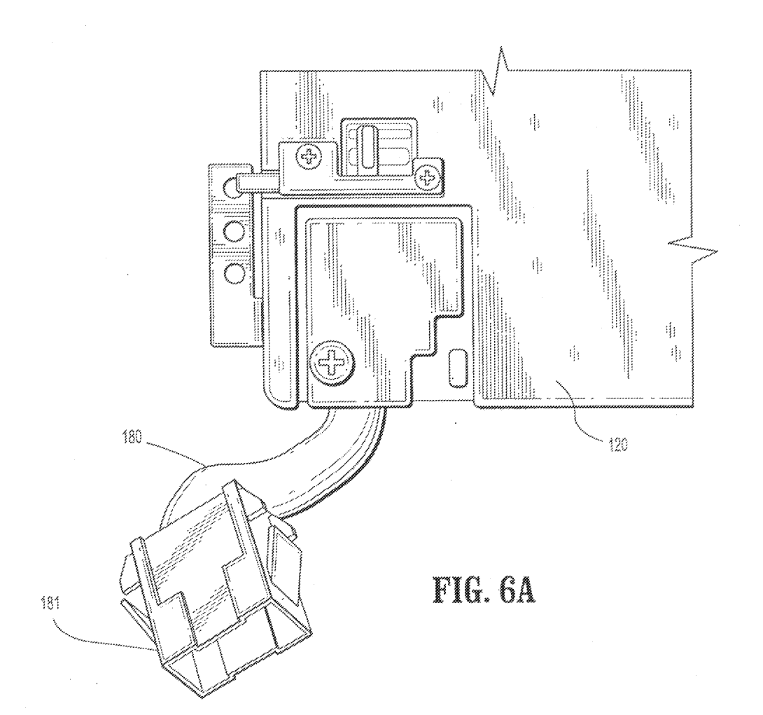

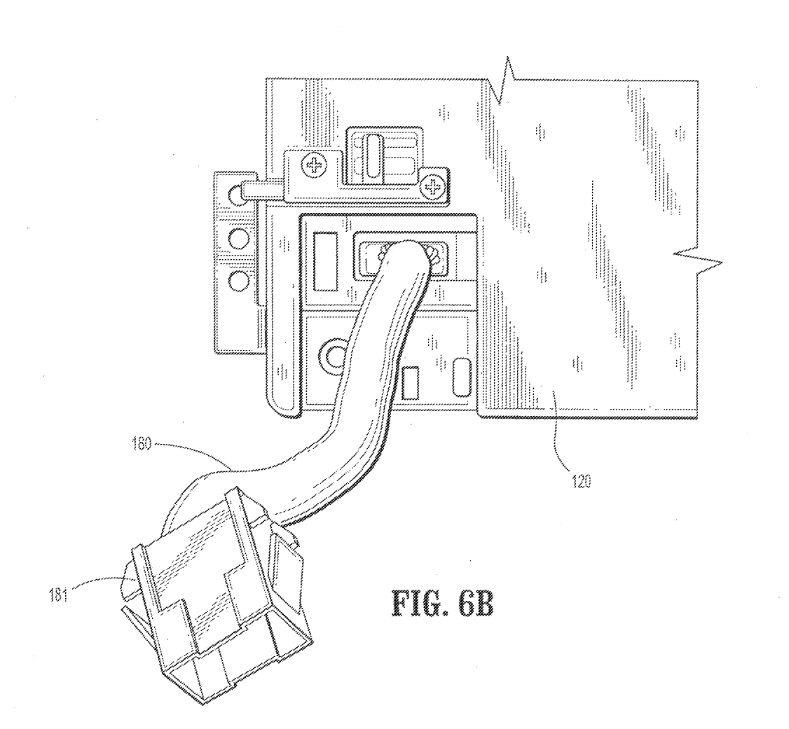

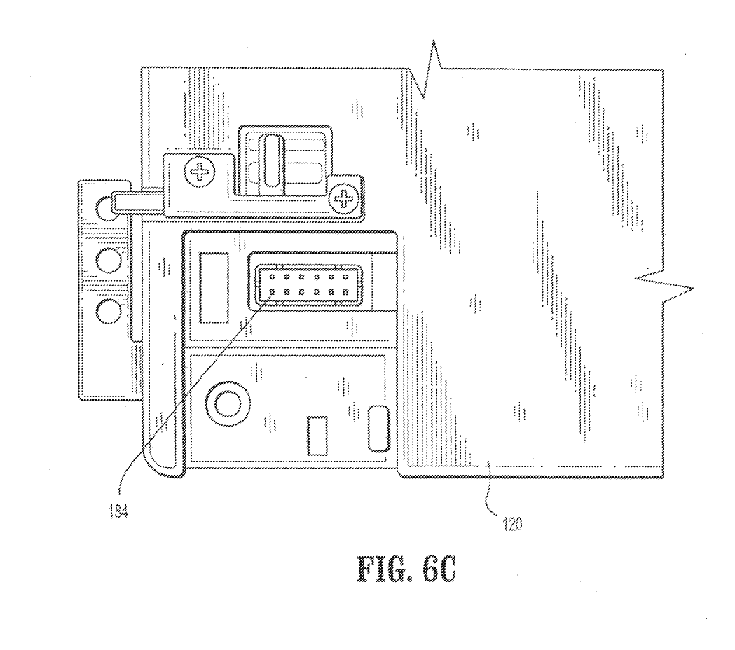

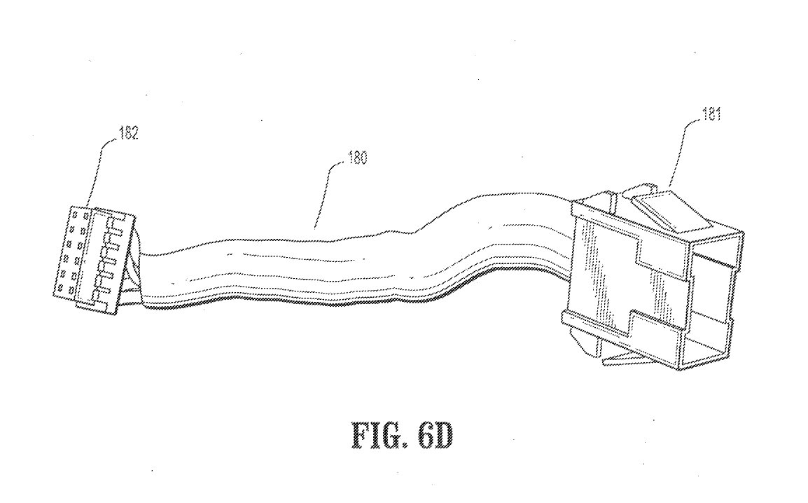

Referring to FIGS. 6A-6D, the wired connection running from the media unit 120 preferably includes a two-headed electrical connector 180, including, for example, pin connectors 181 and 182. The pin connector 181 connects to a mating pin connector 183 positioned in the headrest 10 (see FIGS. 5A-5), which is, in turn, connected to wire 125 running through the headrest support rods 15 to connect to a wire harness (not shown). By unplugging the pin connectors 181, 183 from each other, a user is able to remove the media unit 120 from the headrest 10 without cutting or pulling apart the wires. The pin connector 182 connects to a mating pin connector 184 positioned in the media unit 120. The electrical connector 180 is positioned at a rear portion of the media unit 120, with pin connector 182 connected to pin connector 184.

FIG. 7 shows a front view of a headrest including a first receiving portion and a second receiving portion according to an embodiment of the present invention. Referring to FIG. 7, the headrest 10 includes a first receiving portion A and a second receiving portion B. The media unit 120 is disposed in the second receiving portion B. The second receiving portion B is recessed to receive the media unit, for example, pivotally attached thereto. In an embodiment, two first receiving portions A can be formed, for example, at the bottom corners of the headrest 10. The first receiving portion A and the second receiving portion B can be connected to each other so that a wire from the media unit 120 can be routed out of the headrest 10 via the first receiving portion A. The headrest supports 15 are inserted into the first receiving portion A and are attached to a transverse supporting bar 16 such that the headrest 10 can be securely attached to the headrest supports 15.

FIG. 8 shows wires inserted into first receiving portions according to an embodiment of the present invention. Referring to FIG. 8, the wires 125 including the connectors 150 are fed up the headrest posts 15 into the first receiving portions A of the headrest 10. To facilitate an efficient feeding, the connectors 150 can be wrapped with, for example, the wire wrapper 170 for covering the connectors 150. The wires 125 are fed through the headrest posts 15. The wires 125 are routed out of the headrest 10 through the first receiving portions A. Then, the wire wrapper 170 can be removed.

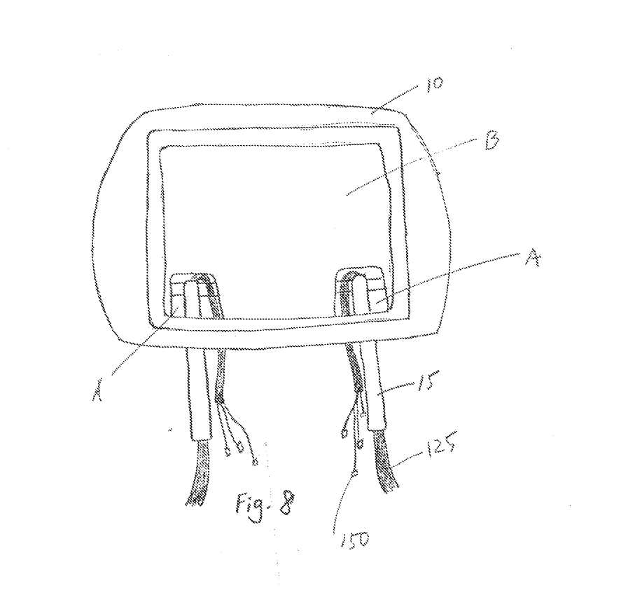

FIG. 9 shows a front view of a headrest and a media unit attached to the headrest according to an embodiment of the present invention. Referring to FIG. 9, the media unit 120 is pivoted away from the second receiving portion B of the headrest 10. The media unit 120 includes wires 225 carrying, for example, power, audio and video signals, and having a plurality of connectors 250 to be mated with connectors 150 of the wires 125. The connectors 150, 250 comprise electrical components for providing at least one of power, ground and audio/video connections for the entertainment system. The wires 225 are routed from the media unit 120 and out of the headrest 10 through the first receiving portion A to connect with the wires 125 having connectors 150.

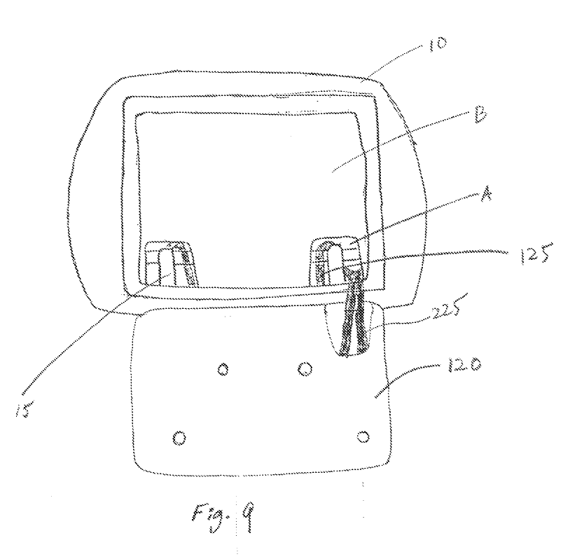

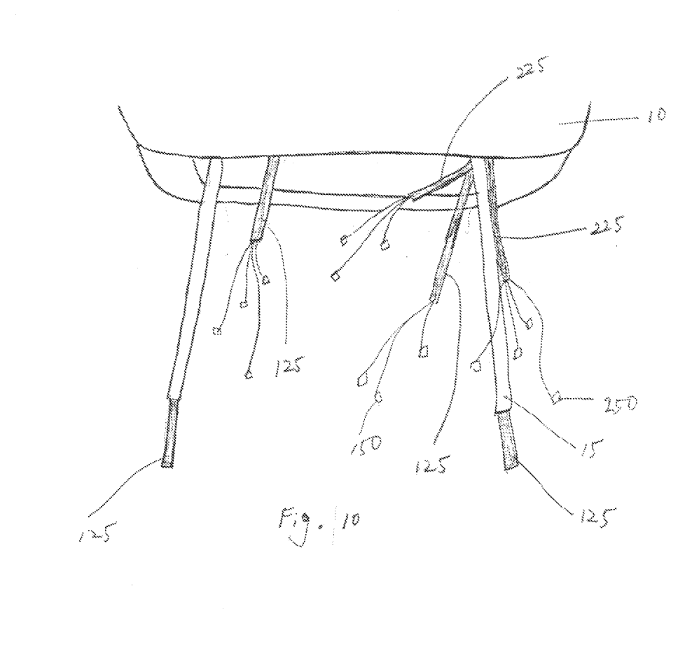

FIG. 10 shows wires and connectors routed out of a headrest according to an embodiment of the present invention. FIG. 11 shows connectors mated with each other according to an embodiment of the present invention.

Referring to FIGS. 10 and 11, the connectors 150 and 250 are mated. Since the mated connectors 150, 250 and harnesses are loosely organized, the connector/harness combination may occupy large space inside the headrest 10. The loosely organized harnesses can be short circuited when contacted with another harness in the headrest 10.

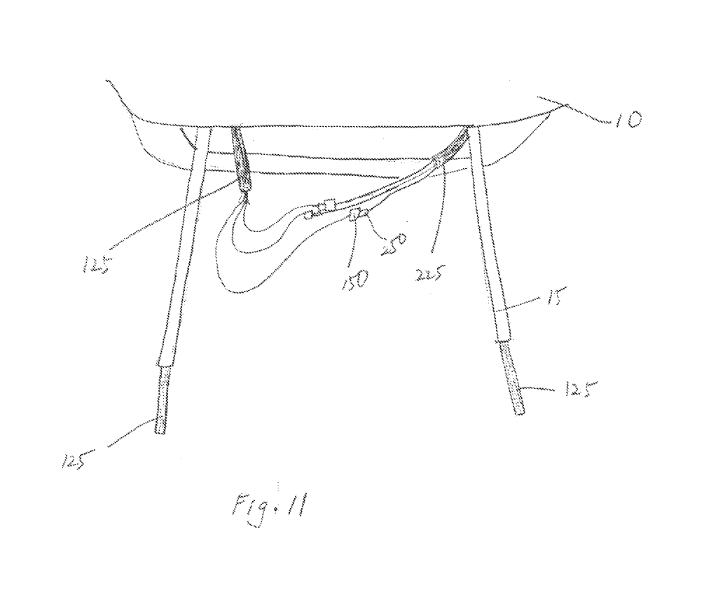

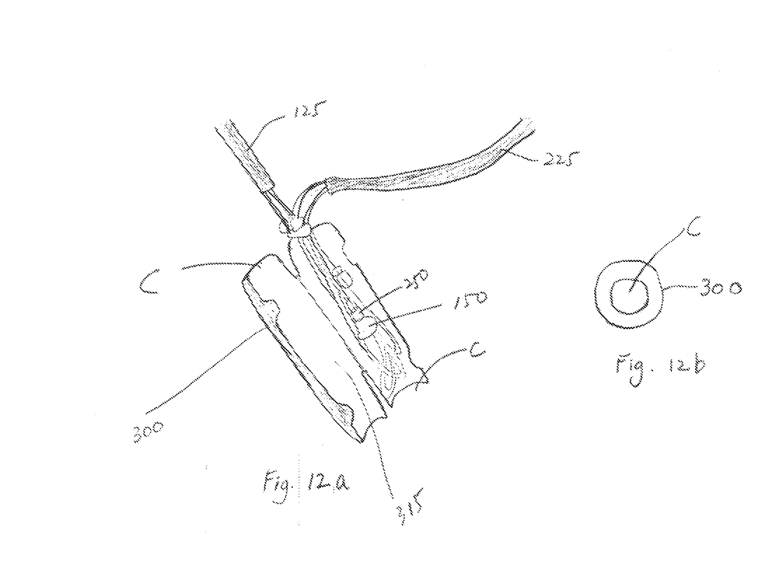

FIG. 12a shows connectors and wires folded and inserted into a connector cover according to an embodiment of the present invention. FIG. 12b shows a front view of a connector cover according to an embodiment of the present invention.

Referring to FIGS. 12a and 12b, the wire harness having the mated connectors 150, 250 can be folded or bent, for example, in half, for reducing the amount of space occupied by the connector/harness combination and placed inside the connector cover 300. In an embodiment, the plurality of wires from each of the wires 125, 225 can be folded inside the connector cover 300 and the connector cover 300 can be snapped closed around the wires 125, 225. In an embodiment, the plurality of wires 125, 225 can be folded outside the connector cover 300 and then inserted into the connector cover 300 through an opening C. The opening C can be formed at one or both sides of the connector cover 300.

The connector cover 300, enclosing the mated connectors 150, 250 and the harness, can be placed inside the headrest 10. The connector cover 300 comprises a cavity 315 to receive the mated connectors 150, 250 and the wire harness. In an embodiment, the connector cover 300 comprises the opening C for guiding the wire harness into the cavity 315. In an embodiment, the connector cover 300 can be formed in, for example, a tube shape. The tube-shape connector cover 300 can be opened into two pieces as shown in FIG. 12a and receives the wire harness inside the cavity 315. The connector cover 300 can comprise, for example plastic.

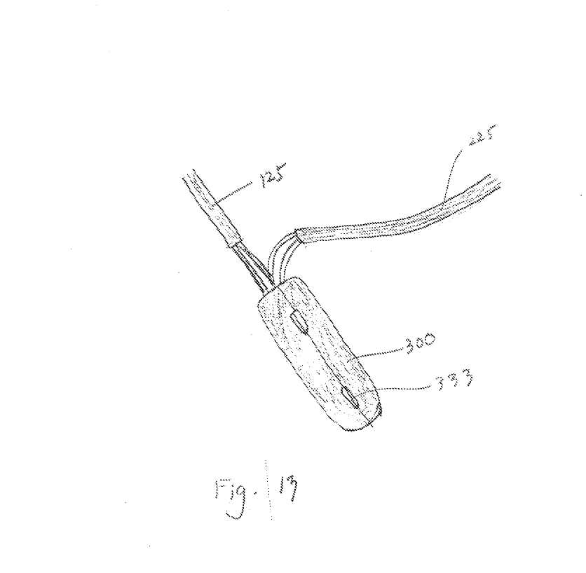

FIG. 13 shows wires inserted into a connector cover according to an embodiment of the present invention. Referring to FIG. 13, once the wire harness having mated connectors 150, 250 are folded, for example, in half, in the connector cover 300, the connector cover 300 is closed using, for example, a mating switch 333. The connector cover 300 can be opened to disconnect the connectors 150, 250 when a different media unit is used.

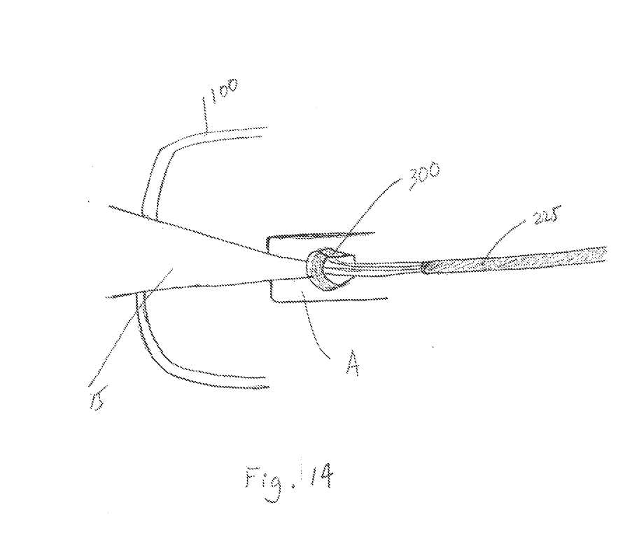

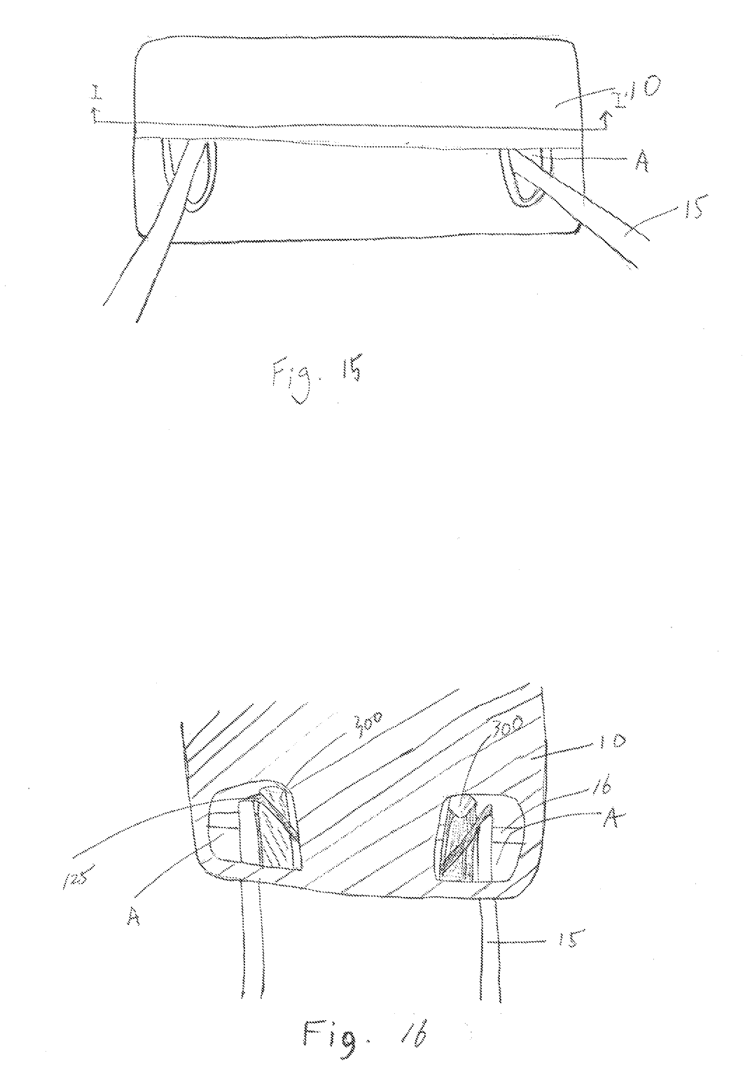

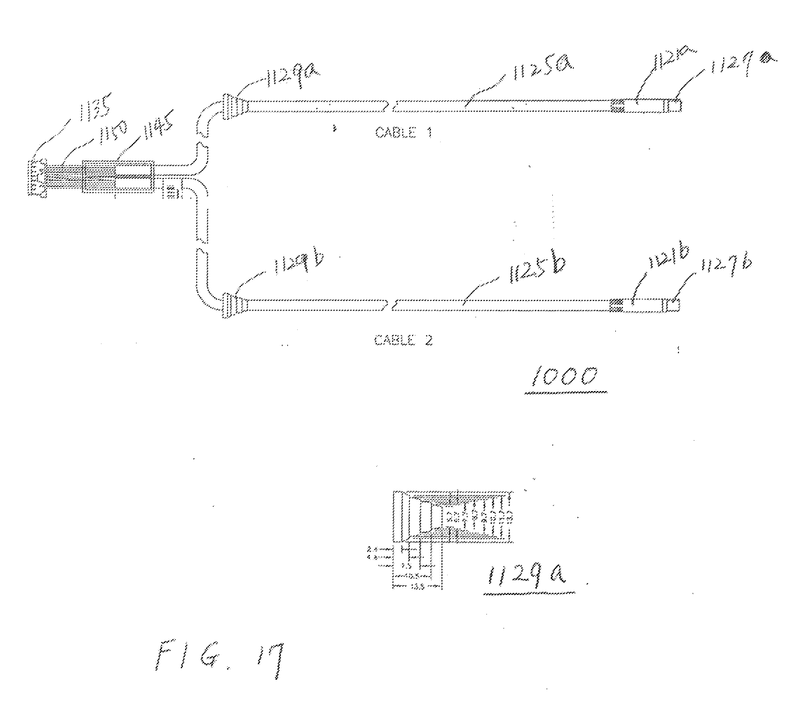

FIG. 14 shows a connector cover inserted into a receiving portion of a headrest according to an embodiment of the present invention. FIG. 15 shows a bottom view of a headrest according to an embodiment of the present invention. FIG. 16 shows a cross-sectional view of a headrest taken along the line I-I′ of FIG. 15 according to an embodiment of the present invention.

The connector cover 300 (see FIGS. 12 and 13) enclosing connectors and harnesses can be placed in the first receiving portion A. The receiving portion A may have a size enough to enclose the connector cover 300.

Referring to FIGS. 14-16, the connector covers 300 are inserted in the first receiving portions A after the connector covers 300 are closed. Each connector cover 300 can be inserted into the first receiving portions A disposed at bottom corners of the headrest 10. In an embodiment, the connector covers 300 can be disposed near the headrest supports 15.

FIG. 17 shows a headrest harness according to an exemplary embodiment of the present invention. The headrest harness 1000 includes a first cable 1125a, a second cable 1125b, and a connecting pin housing 1135. The first cable 1125a and the second cable 1125b can be tied using, for example, a shrink sleeving 1145 at one end of each of the cables 1125a, 1125b. A plurality of wires 1150 in the first and the second cables 1125a, 1125b are received by the connecting pin housing 1135. The first cable 1125a includes a Deutsches Institut für Normung (DIN) connector 1127a, and the second cable 1125b includes a DIN connector 1127b at the opposite end of the connecting pin housing 1135. The first and second cables 1125a, 1125b include strain relievers 1129a, 1129b, respectively.

According to an exemplary embodiment of the present invention, the strain reliever 1129a can have different areas so that the strain reliever 1129a can fit into different sized hollow portions of the headrest post 15 and prevent the cable 1125a from being pulled down the headrest post 15.

According to an exemplary embodiment of the present invention, the plurality of wires 1150 at each end of cables 1125a, 1125b can be enclosed by a first and second wrapping part 1121a, 1121b. Each wrapping part may comprise, for exam pie, plastic or rubber. The first and second wrapping part 1121a, 1121b may have different colors. For example, the first wrapping part 1121a has a blue color and the second wrapping part 1121b has a yellow color. The first wrapping part 1121a having a blue color can be mated with a connector having a blue color. The second wrapping part 1121b having a yellow color can be mated with a connector having a yellow color. Accordingly, plugging a cable into a wrong connector can be prevented. The first wrapping part 1121a, the second wrapping part 1121b and the DIN connectors 1127a, 1127b can be sized small enough to fit through the headrest post 15.

Although exemplary embodiments have been described herein with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A method for preparing a wire for installation in a headrest entertainment system, the method comprising:
forming a receiving portion in a headrest;
inserting a first wire having first connectors through a headrest post and into the receiving portion;
mounting a media device to the headrest, the media device comprising a second wire having second connectors;
connecting the first connectors and the second connectors;
folding the connected first wire and the second wire;
placing the folded wires inside a connector cover; and
inserting the connector cover into the receiving portion.

2. The method of claim 1, further comprising:
wrapping the first connectors attached to the first wire with a wire wrapper for covering the first connectors;
feeding the first wire through the headrest post; and
removing the wire wrapper.

3. The method of claim 1, wherein placing the folded wires inside the connector cover comprises:
opening the connector cover; and
closing the connector cover around the folded wires.

4. The method of claim 1, wherein the receiving portion receives the headrest post.

5. The method of claim 1, wherein the receiving portion is formed near a bottom of the headrest.

6. The method of claim 1, wherein two first receiving portions are formed near bottom corners of the headrest.

7. The method of claim 1, wherein the connector cover is formed in a tube shape.

8. The method of claim 7, wherein the tube-shaped connector cover comprises a cavity.

9. The method of claim 1, wherein the connectors comprise electrical components for providing at least one of power, ground and audio/video connections for the entertainment system.

10. A headrest entertainment system for a vehicle, comprising:
a headrest including a receiving portion;
a first wire having first connectors;
a media device disposed in the headrest, and including a second wire having second connectors; and
a connector cover for receiving mated first and second wires, wherein the connector cover is disposed in the receiving portion.

11. The headrest entertainment system of claim 10, wherein the connector cover comprises a cavity formed therein.

12. The headrest entertainment system of claim 10, wherein the connector cover is formed in a tube shape.

13. The headrest entertainment system of claim 10, wherein two receiving portions are formed near bottom corners of the headrest.

14. A device for preparing a wire for installation in a headrest entertainment system for a vehicle, the device comprising:
a connector cover for receiving the wire including a plurality of connectors in a cavity formed in the connector cover.

15. The device of claim 14, wherein the connector cover is formed in a tube shape.

16. The device of claim 14, wherein the connector cover comprises at least an opening through which the wire is inserted into the cavity.

17. The device of claim 15, wherein the tube-shaped connector cover is opened into two pieces to receive the wire in the cavity.

18. The device of claim 14, wherein the connector cover comprises plastic.
